(19) United States
(12) Patent Application Publication
(10) Pub. No.: US 2007/0275343 A1
(43) Pub. Date: Nov. 29, 2007

(54) Device and method for evaluation of the shade of an object by spectrometry

(76) Inventor: Jean-Pierre Tretout, Clermont (FR)

Correspondence Address: BLAKELY SOKOLOFF TAYLOR & ZAFMAN, 1279 OAKMEAD PARKWAY, SUNNYVALE, CA, 94085-4040, US

(21) Appl. No.: 10/552,845

(22) PCT Filed: Apr. 9, 2004
(86) PCT No.: PCT/FR04/00888

§ 371 Date: Jul. 17, 2006

(30) Foreign Application Priority Data
Apr. 9, 2003 (FR) 03/04386

(51) Int. Cl. A61C 19/04; G01N 21/17

(52) U.S. Cl. 433/29; 356/402; 356/408

(57) ABSTRACT

The invention relates to a device for the automatic determination of the shade of an object (10), comprising a light source, a light sensor, arranged such as to sample the light reflected or passed through the object (20, 30, 40) in a region of the object, and further comprising means for the determination of the wavelength of said light after reflection or passing through the object, said means providing a spectrometric recording corresponding to the sampling region. The above is characterised in that the means for analysis are provided to analyse a number of such spectrometric samples corresponding to different regions (20, 30, 40) of the object (10) and to identify an average spectrometric value from said set of spectrometric samples.

The invention relates to automatic determination of shades by means of optical equipment provided with means for analyzing the received wavelengths, means currently called spectrometers.

Widely used for multiple applications, spectrometers are particularly known for identifying materials, notably from the study of the spectra formed by reflection on such a material.

A spectrometer used for identifying a shade of material is itself also based on the measurement of different wavelengths received after reflection from the material or passing through it.

Such a shade measurement technique has already been proposed in several fields, and notably in the dental field, greatly concerned by the present application.

Thus, spectrometry is today known as a means for replacing the subjective opinion of the practitioner when the matter is to determine the shade of a replacement material to be put into place on a tooth to be treated. The proposed spectrometers for this, typically include a light source and a light sensor followed by means for analyzing the received wavelengths. Computer processing of the produced data automatically indicates the product to be put in place on the tooth.

Such a method is also suitable in other applications which require identification of the shade, even when the matter is not to put into place a replacement product subsequently.

Thus, it is desirable that the input of data relative to encountered colours be automated in many technical fields.

The present application more specifically relates to the concern consisting in determining a shade complying with that perceived by the human eye when the object is examined with the naked eye.

Thus, when the matter is to fill the cavity of a tooth, the concern of the practitioner is that the shade of the introduced material should comply with the general aspect of the tooth, as perceived by a person with the naked eye.

The automatic determination methods for dental shades proposed hitherto have proved to be insufficient as regards this concern.

Indeed, the shades indicated by the existing systems often prove not to match perception of the colour of a tooth by the naked eye.

The reasons, which are at the origin of this drawback, mainly lie in the fact that the tooth is partly translucent and uneven in its surface shape.

The invention proposes to meet this concern, i.e., to propose a device and a method for automatically evaluating the shade of an object where the determined shade truly reflects the shade perceived initially and with the naked eye.

This goal is achieved according to the invention by a device for automatically determining the shade of an object, including a light source, a light sensor, positioned in order to sample on an area of the object the light reflected or passing through the object, further comprising means for wavelength analysis of this light after reflection or passing through the object, and comprising means for inferring a shade from the thereby sampled light, characterized in that the analysis means are provided for analyzing a set of wavelengths sampled in different areas of the object and for identifying a same shade from this set of wavelengths.

A method for determining the shade of an object, is also proposed in the invention, comprising the step consisting of illuminating the object, the step consisting of sampling light after reflection or passing through the object, the step consisting of analyzing wavelengths of the light after reflection or passing through, the step consisting of inferring from this analysis a shade of the object, characterized in that the step consisting of sampling light in different areas of the object, the step consisting of analyzing a set of wavelengths sampled in these different areas, and then the step consisting of identifying a same shade from the analysis of this set of wavelengths, are applied.

Other features, objects and advantages of the invention will become apparent upon reading the detailed description which follows, made with reference to the appended figures wherein:

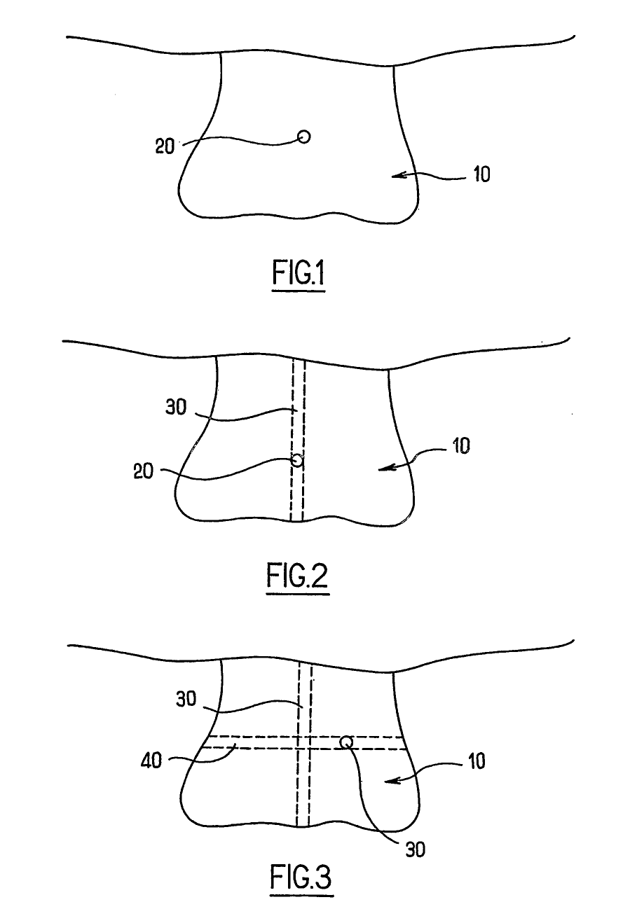

FIG. 1 illustrates a tooth in the process of shade identification according to a known method.

FIG. 2 illustrates a tooth in the process of shade identification according to a first alternative of the invention.

FIG. 3 illustrates a tooth in the process of shade identification according to a second alternative of the invention.

First of all, with reference to FIG. 1, the method utilized up to now for identifying the shade of a tooth before placing a shaded replacement material on the latter, will be described.

First of all, it will be noted that this method relies on the use of a small size spectrometer, suitable for use in the dental field because of its handiness and its capability of being placed precisely.

This spectrometer is logically provided for sampling light reflected by the tooth in a area which may be termed “point-like”.

Thus, in FIG. 1, a spot 20 with a sufficiently small size is illustrated on a tooth 10 in order to represent this area for sampling point light. A selected power illumination is specifically placed on the tooth in order to produce this light spot 20, within which the spectrometer performs its sampling of reflected light. The spot 20 therefore forms the light sampling area for the spectrometric analysis.

In this reflected light, a range of wavelengths is identified by the spectrometer, a range of wavelengths which is considered as specifically describing an optical colour as perceived by the naked eye.

This colour is then compared, by data processing means, with different shades of available replacement products, in order to identify the product having the closest shade to the perceived one.

Although the available spectrometers have quite satisfactory accuracy per se, it is found that the discrepancies which appear between the thereby identified shade and that of the tooth as perceived by the naked eye result from an approach which is too sensitive to colour or geometrical imperfections of the object, the tooth here.

In other words, it is found that the thereby identified shade very exactly represents that of the tooth at the point where the identification was carried out and this point, although appearing to be representative to the eyes of the practitioner, is all the same the centre of an unpredictable discrepancy.

In FIG. 2, a “point-like” light spot 20 also similar to that of FIG. 1, is illustrated on a similar tooth 10. However, it has been identified in the scope of the invention, that the shade differences obtained by spectrometric measurements may be considerably reduced by considering a tooth as a surface having a gradually changing shade on the surface of the latter, although this gradation is not perceivable by the naked eye. By further seeking to perform a mathematical average over this imagined shade gradation, one achieves a particularly advantageous result.

According to this new specifically identified approach, FIG. 2 illustrates a method according to the invention, wherein multiple spectrometric samplings are performed, on a series of points distributed on the tooth.

Averaging over a distribution of spectrometric readings at the surface of the latter is proposed as a corrective basis for an uneven distribution of the shade perception on the tooth.

This distribution is found to correct a perception disparity due to multiple parameters, not necessarily coming under an actual shade disparity, but rather under translucence disparities and disparities in surface geometry of the tooth.

As to these different disparities, the assumption according to which the tooth is an object with gradation of surface shade is a theoretical model, allowing the invention to be applied, more than a reality actually perceived by the naked eye.

How this plurality of samplings is preferentially applied, and the associated means, will be described hereafter, as well as the preferential distributions to be applied over the tooth.

The applied means here in addition to the spectrometer with optical illumination and read-out, first consist of means for mechanically displacing the sampling area on a predefined path. Thus, the illumination spectrometer is provided with a rail and a mechanical displacement means on this rail along a rectilinear displacement segment with a predetermined length.

Preferentially, the spectrometer provided with these rail displacement means, is also provided with means for positioning it relatively to the patient, allowing the positioning of the rail to be adjusted relatively to the tooth, and thus the selected displacement for the plotting area 20.

Thus, according to the illustration of FIG. 2, the plurality of sampling points preferentially consist in a segment 30 extending longitudinally on the tooth, i.e., gradually moving away from the gum and perpendicularly to the latter. The sampling points on this segment 20 may be selected in a variable number, which may range from a few sampling points to several thousands.

Such a positioning of these points on the longitudinal axis of the tooth is found to provide a shade identification which in particular truly reflects the one perceived by the naked eye.

Each sampling point corresponds to a reading of a range of wavelengths present at this point. In this range of wavelengths present at a point, the latter are represented with different powers, the most powerful wavelengths being considered as representing the colour in presence at the best.

The analysis means proposed here take into account the whole of the ranges of wavelengths read at each sampling points, and by averaging the read powers for each wavelength at different points, they establish an average range of wavelengths present on the tooth, an average range in other words consisting in a reading where each relevant wavelength has a power corresponding to the average encountered power on the different points of the tooth.

The most powerful wavelengths in this average range represent the colour of the tooth.

Moreover, the colour of the tooth may be identified, in an alternative which is simple to achieve, by establishing a global average of the wavelengths represented in the average range, wavelengths weighted with their respective powers in this average range.

However, according to a second alternative illustrated in FIG. 3, such a longitudinal (vertical) scan 30 is advantageously completed with a transverse (horizontal) scan 40 on the tooth, i.e., a scan substantially parallel to the gum.

This transverse scan is preferably placed at half-height of the visible portion of the tooth.

Also, in this case, the whole of the spectrometric readings, i.e., those obtained with the vertical scan 30 and with the transverse scan 40, are submitted to mathematical averaging in order to determine an average range of wavelengths represented on the tooth.

In other words, the desired colour is determined by analysis of the average range, for example by considering it as a standard spectrometric reading.

In a preferential alternative, the device is provided with a camera and video display means in order to display the examined object on a screen.

On this screen, the sampled shades are plotted on each of the points of the object, so that the displayed representation bears the shades as read by the device.

The user thus examines the processing work performed by the device, and notably the distribution of the shades before averaging them. The device is preferentially provided with interactive means allowing the user to select a specific portion of the thereby displayed object, in order to establish the global shade of the object from the relevant portion.

In other words, the device is provided with means for controlling the shade analysis discussed earlier, control means which define, under the control of the user, the particular portion of the object which should be taken into account in calculating the shade. The other portions of the object are, in other words, excluded from the shade calculation.

Thus, the user, for example, selects a position of the object which specifically seems to him to be representative of the global shade of the latter.

The invention is not limited to both of these preferential embodiments, but may also be applied via a plurality of readings and a subsequent averaging, wherein the plurality of readings may be distributed differently over the tooth, and this irrelevant to any scanning consideration.

The concern having been met here, that of accurately re-transcribing the general perception of shape as perceived by the naked eye is also present in other types of application just as much concerned by the present invention.

Thus, more generally, the invention may be applied for efficiently re-transcribing the impression to the eyes of an expert capable of evaluating a particular condition of a product.

Thus, it is found that applying a spectrometer and a multiplicity of readings distributed over an extended area of an object, is an advantage, in the case of evaluation of a colour on a fruit, for which it is desired to automatically evaluate the ripeness from this colour or any perishable foodstuff.

Another type of application consists of evaluating the shade of a work of art in order to evaluate its age or its preservation condition.

The invention is also advantageously used for determining the shade of an area of a banknote, in order to determine if the latter is authentic.

1. A device for automatically determining the shade of an object (10), including a light source, a light sensor positioned so as to sample on a area of the object, light reflected or passing through the object (20, 30, 40), further comprising means for wavelength analysis on this light after reflection or passing through the object, these means delivering a spectrometric reading corresponding to the sampling area, characterized in that the analysis means are provided for analyzing a set of such spectrometric readings corresponding to different areas (20, 30, 40) of the object (10) and identifying an average spectrometric reading from this set of spectrometric readings.

2. The device according to claim 1, characterized in that it comprises means provided for automatically displacing the light sampling area over an extended area of the surface of the object.

3. The device according to claim 1 or claim 2, characterized in that the device is provided for sampling light in a plurality of points (20, 30, 40) over a surface having a relief.

4. The device according to any of the preceding claims, characterized in that the device further includes a camera and means for displaying an image of the object (10) as sampled by the camera, as well as means for plotting on this image a series of shades sampled at said series of sampling points (20, 30, 40), at their corresponding location on the object (10) displayed on the screen.

5. The device according to claim 4, characterized in that it includes means allowing a user to perform a spatial selection of the object represented on the screen, means being provided for expressing this spatial selection as a selection of sampling points from light samplings performed on these points specifically positioned in this spatial selection, and for calculating the global shade from light samplings performed on these points.

6. The device according to any of the preceding claims, characterized in that it is intended for determining the shade of a tooth (10).

7. The device according to any of the preceding claims, characterized in that it includes means for displacing a spectrometric sensor along a sampling line (30, 40) extending over the object (10).

8. The device according to any of the preceding claims, characterized in that it comprises means for using the average spectrometric reading in order to define the shade of a material subsequently added to the object (10).

9. A method for determining the shade of an object (10), comprising the step consisting of illuminating the object (10), the step consisting of sampling the light after reflection or passing through the object, the step consisting of analyzing wavelengths of the light after reflection or passing through, in order to establish a spectrometric reading of a relevant area of the object (10), the step consisting of inferring from this analysis a shade of the object, characterized in that the step consisting of sampling light in different areas (20, 30, 40) of the object (10), the step consisting of analyzing a set of sampled wavelengths in different areas (20, 30, 40) for establishing a plurality of spectrometric readings corresponding to these different areas, and then the step consisting of identifying an average spectrometric reading from this set of spectrometric readings, are applied.

10. The method according to claim 9, characterized in that it is applied to the determination of the shade of a tooth (10).

11. The method according to claim 10, characterized in that the plurality of points describes at least one segment (30) orientated longitudinally to the tooth (10), i.e., substantially perpendicularly to the gum.

12. The method according to claim 10 or claim 11, characterized in that at least one portion of the plurality of sampling points (20, 30, 40) describes a segment (40) substantially aligned with the gum, i.e., perpendicularly to the main axis of the tooth (10).

13. The method according to any of claims 9 to 12, characterized in that it comprises the step consisting of displacing a spectrometric sensor along a sampling line (30, 40) extending over the object (10).

14. The method according to any of claims 9 to 13, characterized in that it comprises the step consisting of using the average spectrometric reading for defining the shade of a material subsequently added to the object (10).
